(19) United States
(12) Patent Application Publication
(10) Pub. No.: US 2008/0008782 A1
(43) Pub. Date: Jan. 10, 2008

(54) Method of Preparing a Bread Dough or Part Baked Bread

(75) Inventors: Robert Jan Hamer, Amersfoort (NL); Cristina Primo-Martin, Venray (NL)

Correspondence Address: SUGHRUE MION, PLLC, 2100 PENNSYLVANIA AVENUE, N.W., SUITE 800, WASHINGTON, DC, 20037, US

(73) Assignee: Wageningen Centre for Food Sciences, Wageningen (NL)

(21) Appl. No.: 10/598,049

(22) PCT Filed: Feb. 16, 2004
(86) PCT No.: PCT/NL05/00112

§ 371 Date: Nov. 8, 2006

(30) Foreign Application Priority Data
Feb. 17, 2004 (EP) 04075505.0

(51) Int. Cl. A23L 1/105; A21D 10/00; A21D 13/00

(52) U.S. Cl. 426/63; 426/549

(57) ABSTRACT

The present invention relates to a method of preparing a bread dough and a part baked bread comprising. (a) mixing flour, water and optionally other bakery ingredients to form a bread dough: (b) optionally part baking the dough to obtain a part baked bread; and (c) applying an enzyme material with proteolytic activity to the outside surface of the dough or the part baked bread. The bread dough and part baked bread obtained by the present method offer the advantage that they can be baked to yield a bread product that will retain a crispy crust for a considerable period of time alter baking

### TECHNICAL FIELD OF THE INVENTION

The present invention relates to a method of preparing a bread dough and a part baked bread. The bread dough and part baked bread obtained by the present method offer the advantage that they can be baked to yield a bread product that will retain a crispy crust for a considerable period of time after baking.

Another aspect of the invention relates to bread dough product or part baked bread that can be obtained by the aforementioned method.

### BACKGROUND OF THE INVENTION

Staling of bread is accompanied by changes in both crust and crumb. These changes include loss of flavour, increase of crumb hardness and crumbliness as well as loss of crispness of the crust. Bread crust in a freshly baked state is dry, crispy and brittle, but it loses it crispness upon staling, resulting in a soft, tough crust.

Moisture redistribution is generally accepted to be the major cause of crust staling. Migration of water causes hydration of the crust and may induce a transition at room temperature of amorphous regions in polymers that were initially in the glassy state. As a result the crust loses its crispy character.

Two different mechanisms may lead to hydration of the crust. The moisture gradient that exists in freshly baked bread between the ‘wet’ crumb and the dry crust causes migration of water from the inside crumb to the crust. Furthermore, the crust may absorb water from the surrounding atmosphere. The storage conditions play an important role. High humidity conditions stimulate water absorption, whereas a low humidity may cause drying out (water desorption) of the crust. Thus, the moisture gradient within the bread and between the bread and the environment conditions are driving forces for the water transport that occurs in freshly baked bread in order to reach thermodynamic equilibrium (Labuza and Hyman, 1998).

A crispy crust is an important quality parameter of freshly baked bread. If crispiness is lacking, consumers will perceive the bread as not being fresh. Since the crust of freshly baked bread will lose its crispy nature over time the quality of the bread is perceived to decrease at the same rate.

GB-B 906 344 relates to a bread additive which enhances the leavening of the bread and which minimises the rate at which the bread becomes stale. The additive contains at least one proteolytic enzyme derived from Bacillus subtilis or Aspergillus oryzae.

U.S. Pat. No. 3,934,040 describes a process of making a yeast leavened bread dough product comprising the steps of:
a. forming a dough by combining normal bread dough ingredients with L-cysteine and ascorbic acid and including enzymes in said dough selected from the group consisting of fungal alpha amylase, fungal protease, bromelain and papain;
b. extending said dough; and
c. baking said extended dough.

EP-A 0 617 896 is concerned with providing a method for producing an edible starch based bread-type product that exhibits reduced microwave-induced toughness and/or firmness. On page 7, lines 17-18 it is observed that surfactants (emulsifiers) may be used to reduce protein-protein interaction and subsequent toughening induced by microwave irradiation. Example V describes the effect or protease on firmness and toughness of a frozen biscuit dough product. The protease ex B. subtilis is incorporated into the biscuit dough together with other dough ingredients.

EP-A 1 350 432 describes a method and composition for retarding staling of bread by incorporating a thermostable protease into the bread dough.

### SUMMARY OF THE INVENTION

The inventors have discovered that the crispy crust of baked bread will retain its crispy character for a prolonged period of time if protease or peptidase is applied to the outside of the bread dough or part baked bread prior to baling or bake off.

U.S. Pat. No. 6,174,559 and U.S. Pat. No. 6,197,353 describe film forming colloidal dispersions containing gluten-derived proteins and peptides that can be coated onto a variety of substrates to provide a glossy sheen to the substrate. The method for producing these gluten-derived colloidal dispersions comprises the steps of preparing an aqueous dispersion of gluten under agitating conditions; heating the product to gelatinize the starch contained in the gluten; hydrolysing essentially all starch within the dispersion with a starch hydrolysing enzyme; hydrolysing protein contained in the gluten using a protease under conditions sufficient to change the gluten dispersion viscosity. In addition, these US patents teach to heat the colloidal dispersion to inactivate the protease.

Furthermore, it is known in the bakery art to use proteases in bread dough preparation to improve handling properties and to produce a smooth dough. In continuous mix systems and extruded dough, proteases will give better dough handling with less wear and tear on the machines. The application of active protease onto the outside surface of dough or part baked products has not been disclosed in the prior art.

Although the inventors do not wish to be bound by theory, it is believed that the protease present in the enzyme material will degrade proteins and/or peptides present in the outside layer of the (part baked) dough product. As a result of this degradation the characteristics of the outside layer of the dough are fundamentally changed as becomes evident after baking in the crust properties of the baked product and especially the crust behaviour during storage.

### DETAILED DESCRIPTION OF THE INVENTION

Accordingly, one aspect of the invention relates to a method of preparing bread dough or a part baked bread comprising:
a. mixing flour, water and optionally other bakery ingredients to form a bread dough;
b. optionally part baking the dough to obtain a part baked bread; and
c. applying an enzyme material with proteolytic activity to the outside surface of the dough or the part baked bread.

The term “bread” as used herein refers to flour based leavened baked products, not including baked products obtained from laminated dough, such as croissants, Danish pastry and puff pastry. Similarly, the term “bread dough” or “dough”, unless indicated otherwise, does not encompass laminated dough.

The terminology “part baking” refers to the incomplete baking of a bread dough resulting in a product that needs to be subjected to another baking step to yield a fully baked bread. Typically, the part baked bread does not exhibit the strong crispy crust that is typical of fully baked bread.

The terminology “enzyme material with proteolytic activity” as used herein refers to an edible material that can suitably be used in the food industry to deliver such enzyme activity to foodstuffs. The term does not encompass food materials, e.g. flour or yeast, that naturally contain some proteolytic activity but which are not suitable for delivering significant levels and types of enzyme activity. The term “proteolytic activity” refers to the capability of an enzyme to split proteins or peptides into smaller peptides or amino acids.

Typically, the enzyme material employed in accordance with the present invention exhibits a proteolytic activity of at least 0.01 Units per gram of dry matter. Here one Unit of proteolytic activity is defined as the amount of material that will hydrolyse one micromole of benzoyl-L-arginine-p-nitroanilide per minute at 22° C. and pH 6.5. Preferably, the enzyme exhibits a proteolytic activity of at least 0.05 Units, even more preferably of at least 1 Unit per gram of dry matter. In addition, the proteolytic activity of the enzyme material preferably does not exceed 1000 Units per gram of dry matter.

In another preferred embodiment of the invention, the enzyme material is applied to the outside surface of the dough or part baked bread in an amount of at least 1×10⁻⁴ Units, more preferably at least 3×10⁻⁴ Units proteolytic activity per cm². Typically, the amount of proteolytic activity applied will not exceed 0.1 Units per cm². Here the amount of enzyme activity delivered to the surface is to be calculated on the basis of the surface area to which the enzyme material was actually applied.

The application of the enzyme material in accordance with the present invention causes degradation of proteins and/or peptides contained in the outside layer of the dough product or part baked product. This degradation results in an increase in free primary amino groups in the outside layer. Typically, following treatment of the outside of the product with the enzyme material, the content of primary amino groups in the top layer has increased by at least 5%, preferably by at least 7%, more preferably by at least 15, even more preferably at least 25% and most preferably by at least 35% in comparison to a non-treated product. Here the term “top layer” refers to the very thin (<1 mm) outside layer of the product that is in direct contact with the surrounding atmosphere. Generally, the content of primary amino groups in the top layer will not increase by more than 80%, preferably by not more than 60% as a result of the present method. The concentration of primary amino groups in the dough, the part baked product or in the crust of the final product may suitably be determined by means of an ortho-phtaldialdehyde assay as described by Church et al. (“Spectrophotometric assay using o-phthaldialdehyde for determination of proteolysis in milk and isolated milk proteins” Dairy Sci, (1983) 66, 1219-1227).

The enzyme material employed in the present process advantageously contains one or more industrial enzymes that are approved for use in food and that exhibit considerable proteolytic activity, especially endoprotease and/or endopeptidase activity, such as metallo proteinases and serine proteases. The proteolytic enzymes in the present enzyme material may suitably be derived from plant, microbial or animals sources. Particularly preferred are enzymes derived from plant, fungal or bacterial sources, plant and fungal sources being even more preferred, and botanical enzymes being most preferred. Preferably other enzyme activities are essentially absent. Examples of enzymes that are particularly suitable for use in the present method include papain, bromelain, ficin, trypsin, chymotrypsin, Corolase™ and debitrase™.

In order to avoid excessive browning of the crust during baking, it is preferred to employ an enzyme material that contains a limited amount of reducing sugars. Typically, the amount of reducing sugars in the present enzyme material does not exceed 1 gram per Unit of proteolytic activity. Even more preferably, the amount of reducing sugars does not exceed 0.1 gram per Unit. In the present method the enzyme material may be applied by any technique that is suitable for depositing a relatively thin homogeneous layer onto the outside of the product. Suitable techniques, include spraying, brushing, pouring, dipping, sprinkling etc. Most preferably the enzyme material is applied by spraying, dipping or brushing. In a particularly preferred embodiment, the enzyme material is applied in the form of a liquid, preferably an aqueous suspension. Here the term liquid also encompasses highly viscous liquids that have the advantage that they will stick to the dough or part baked bread. It should be understood that the present invention also encompasses embodiments wherein the enzyme material is applied indirectly, e.g. by spraying or brushing the enzyme material onto the inside of the tins that are used for baking tin bread.

In the preparation of the present bread dough the flour and water may suitably be combined with a variety of bakery ingredients, e.g. yeast, fat, salt and/or enzymes. Yeast is a particularly important ingredient that is commonly used in bread dough to create an open internal structure. To allow the yeast to deliver this functionality, the dough is allowed to rest or proof for at least a few minutes before the dough is (part) baked or frozen.

The bread dough or part baked bread according to the invention is suitably manufactured by means of a method that employs the step of proofing the bread dough. The enzyme material may suitably be applied prior to or after such proofing step. Applying the enzyme material prior to proofmg offers the advantage that the dough is less vulnerable and that the enzymes within the enzyme material are allowed sufficient time to degrade proteins and or peptides present in the exterior layer of the dough. Furthermore, if the enzyme material is applied prior to proofing, less proteolytic activity may be required to achieve the same result as in case the enzyme material is applied later on in the manufacturing process.

Alternatively, the enzyme material is applied after proofing. In this embodiment the dough product is advantageously frozen or (part) baked within a predetermined period of time after completion of the proofing step, .e.g. within 30 minutes. Thus, the impact of the protease treatment may be controlled effectively as both baking and freezing inhibit enzyme activity.

The term “proofing” as used herein refers to a dough treatment that allows the yeast in the dough to exert its action under optimised conditions. Typically, proofing involves placing the bread dough into a proofing cabinet in which an elevated temperature and controlled humidity are maintained.

The inventors have found that the crust quality of the baked bread may be further improved by applying the enzyme material to the outside surface of the bread dough or part baked bread in combination with one or more components selected from the group consisting of fat, cystein, cystin and casein. In a particularly preferred embodiment the latter one or more components are incorporated into said enzyme material.

The present invention offers an important unexpected benefit in that the favourable crust properties of the fully baked bread are retained for a prolonged period of time even if the dough or part baked bread is frozen and stored as such for a considerable period of time. Consequently, in a highly preferred embodiment, the dough or part baked bread is frozen and stored in frozen form for at least 1 day, preferably at least 3 days, following application of the enzyme material.

Another aspect of the invention relates to a bread dough product or a part baked bread product exhibiting proteolytic activity on the outside surface of the product and exhibiting significantly less proteolytic activity in the interior of the product, said interior of the product being located at least 2 cm away from the outside surface. The interior of the product may exhibit proteolytic activity because it contains bakery ingredients that naturally exhibit some proteolytic activity. Also, the dough may contain added enzymes that deliver proteolytic activity. However, in accordance with the present invention, the proteolytic activity inside the product is significantly lower than the same activity on the outside surface. Typically, the proteolytic activity inside the product is at least 10 times, more preferably at least 50 times and most preferably at least 100 times lower than the same activity on the outside surface. The proteolytic activity is suitably determined by means of any known assay that is designed for quantifying the activity of the protease(s) present on the surface of the product.

Similarly, also the concentration of primary amino groups in the outside layer of the dough product is significantly higher than in the product's interior. Typically, the concentration of primary amino groups in the top layer of the dough product is at least 5% higher, preferably at least 7% higher, more preferably at least 10% higher and most preferably at least 15% higher than inside the product, the inside of the product being located at least 2 cm away from the outside surface.

In part baked bread products and fully baked bread products the concentration of primary amino groups in the crust is always lower than the same concentration within the crumb. As a result of pre-treatment of bread dough or part baked bread in accordance with the present invention the concentration of primary amino groups in the curst will typically be increased to a level that exceeds the concentration of primary amino groups in the crumb. Thus, in such part of fully baked products the concentration of primary amino groups in the crust preferably exceeds the concentration of primary group in the crust, more preferably it exceeds said concentration by at least 10%.

It should be noted that the enhanced proteolytic activity does not need to be evident on the complete outside surface of the present (part baked) dough product. Indeed, it may be practical to only deliver the desired enzyme activity to the parts of the product that are visible when the product is lying on a flat surface. Typically, at least 30%, preferably at least 50% of the outside surface of the present dough product or part baked bread product will exhibit enhanced proteolytic activity as defined herein. Most preferably, at least 80% of the outside surface exhibits such enhanced enzyme activity.

As described herein before, the proteolytic activity on the outside surface preferably exceeds 1×10⁴ Units per cm². Again, these activities relate to the part of the outside of the product to which enzymes exhibiting these activities have been applied.

In a particular preferred embodiment the present bread dough product or part baked bread product is frozen, preferably deep-frozen. The frozen product is suitably packaged in a material that carries instructions as to how to bake or bake off the product.

Yet another aspect of the invention relates to a method of preparing baked bread from a bread dough or from a part baked bread, said method comprising baking a bread dough or part baked bread obtained by a method as defined herein before or by baking a dough product or part baked bread product as defined above. The advantages of the invention are particularly evident if the baked product so obtained is characterised by a crust with a moisture content of less than 25 wt. %, preferably of less than 20 wt. %, even more preferably of less than 18 wt. %. The baked product obtained after baking the present dough product or part baked bread product retains a crispy crust for a prolonged period of time even when stored under ambient conditions. In contrast, dough products or part baked bread products that are comparable to the present products, but which do not contain the added proteolytic activity on the dough surface, exhibit considerable crust softening when stored under comparable conditions.

Finally, the invention provides a new use of an enzyme material exhibiting proteolytic activity. More particularly, this aspect of the invention relates to the use of such an enzyme material for improofing the crispiness of baked bread, said use comprising applying the enzyme material to the outside surface of a bread dough or a part baked bread prior to final baking.

The invention is further illustrated by means of the following examples.

### EXAMPLES

### Example 1

Part-baked rusk rolls were prepared using two wheat flour cultivars, Soissons and Spring. The composition of the flours is shown in table 1.

TABLE 1

| | Water | | | | | Damaged |
|---|---|---|---|---|---|---|
| | absorption %^{a} | Moisture % | Ash % | Protein % | Starch % | Starch % |
| Soissons | 56.5 | 14.1 | 0.58 | 10.9 | 77 | 6.0 |
| Spring | 61.5 | 14.1 | 0.57 | 16.5 | 74 | 6.7 |

^{a}farinograph (Brabender),
b: alveograph (Chopin).

The bread dough was prepared by mixing wheat flour (3000 g), water (1695/1846 mL for Soissons and Spring, respectively), yeast (50 g), salt, ascorbic acid and calcium propionate in a high speed mixer. Dough was mixed to a final temperature of 26° C. Then, the dough was allowed to rest for 15 min, divided and rounded. Proofing was performed until 500 mL gas had been produced by the dough sample.

In order to modify the bread crust properties the surface of the proved dough pieces was treated with an aqueous solution of protease (Profix™ 200L). Profix™ 200L is an endo-protease (papain; 10.2 units/mL) from Quest International B.V. One Unit will hydrolyse one micromole of Benzoyl-L-Arginine-p-nitroanilide per minute at 22 (C and pH 6.5 under the specified conditions. As a control water was sprayed instead of the enzyme solution.

The protease had been pretreated by passing it through a PD-10 desalting columns (Amersham Pharmacia Biotech) to remove low molecular weight components (e.g. reducing sugars). The pretreated enzyme solution (1 g of protease per 30 mL) was sprayed over the surface of the dough after proofing and immediately before part-baking. In this way it was ensured that the enzymes only modify the surface of the dough, which is converted into the bread crust during baking. The amount of enzyme solution used per dough piece of an area of about 50 cm², was 0.4 g, enough to cover the whole surface by means of spraying. Thus, 0.0027 Units of proteolytic activity were delivered per cm².

The breads were part-baked at 215 ° C. during 12 min. The part-baked breads were allowed to cool down for 30 min and then were frozen (−30(C) and stored frozen. The part baked breads were baked off in a Bakermat Mastermind oven (Leventi). The bake off conditions were: pre heating of the oven at 250(C, 5 s steam, 235(C convection during 5 min.

After baking the breads were allowed to cool down during 0.5 h (fresh bread). Next, the baked bread was stored using two different storage regimes: the breads were stored in a climatic cabinet Weiss SB 11300 at 22(C and at 80(2% as well as 40(2% relative humidity (RH).

Crust samples were taken from baked breads, freeze dried and extracted with 1.5% SDS containing 5% β-mercaptoethanol. Subsequently, an ortho-phtaldialdehyde assay was used to determine the degree of modification of free primary groups as described by Church et al. The results showed a degree of modification caused by the protease treatment of 37% and 38% in the bread rolls prepared with Soissons and Spring flour respectively, relative to control samples.

Sensorial analysis of the bread samples was performed at 0.5 (fresh bread) and 2 hours after bake off. Trained panellists using graduated scales from 0 to 10 between extremes performed the sensorial evaluation of the bread crust. Analysed variables at the first bite were:
not crispy-crispy;
wet-dry;
tough-brittle;
soft-hard;
no noise-noisy;
   with the first parameter scored as 0 and the second as 10.

The definitions used for the parameters were: Crispy: cracks, you can force your teeth through slowly, more airy than cracky. Brittle: airy, not hard, but giving resistance. Hard: resistance, with sound, snaps, bite force needed. Tough: requires pulling to tear off.

The sensorial evaluation of the crust showed that the different flour types produced fresh bread of similar crispness. In both Soissons breads and Spring breads protease was found to have slightly improved the crust characteristics of fresh balked bread as evidenced by the scores for the attributes “crispy” and “brittle”. The evaluation of the crust from whole breads stored at 80% RH revealed a rapid loss of the crispy features of the bread 2 hours after bake off in the control breads. In contrast, these features were found to have hardly decreased in the breads that had been treated with protease, as is evident from the results presented in Table 2.

TABLE 2
(Storage at 40% and 80% Relative Humidity)

| | | Crispy | Dry | Brittle | Noise | Hard |
|---|---|---|---|---|---|---|
| FRESH | Control | 7.6 | 7.3 | 6.6 | 7.9 | 6.3 |
| | (Soissons) | | | | | |
| | Protease | 8.8 | 8.3 | 8.8 | 8.9 | 5.5 |
| | (Soissons) | | | | | |
| | Control (Spring) | 7.6 | 7.6 | 6.6 | 7.1 | 5.7 |
| | Protease (Spring) | 8.6 | 7.8 | 8.6 | 8.6 | 5.6 |
| AFTER | Control | 2.2 | 7.3 | 5.9 | 2.1 | 3.1 |
| 2 HOURS | (Soissons) | | | | | |
| AT RH | Protease | 6.4 | 8.7 | 6.3 | 6.9 | 5.8 |
| 80% | (Soissons) | | | | | |
| | Control (Spring) | 0.6 | 4.3 | 0.6 | 0.7 | 0.9 |
| | Protease (Spring) | 4.5 | 5.3 | 4.8 | 5.0 | 5.5 |
| AFTER | Control | 7.5 | 8.1 | 6.9 | 7.1 | 4.8 |
| 2 HOURS | (Soissons) | | | | | |
| AT RH | Protease | 7.8 | 7.4 | 8.1 | 8.2 | 5.6 |
| 40% | (Soissons) | | | | | |
| | Control (Spring) | 3.5 | 5.7 | 3.7 | 3.4 | 3.8 |
| | Protease (Spring) | 8.2 | 7.8 | 7.5 | 8.1 | 5.1 |

1. A method of preparing a bread dough or a part baked bread comprising:
a. mixing flour, water and optionally other bakery ingredients to form a bread dough; and
b. applying an enzyme material with proteolytic activity to the outside surface of the dough.

2. Method according to claim 1, wherein the enzyme material exhibits at least 0.1 Units of proteolytic activity per gram of dry matter, one Unit of proteolytic activity being defined as the amount of material that will hydrolyse one micromole of benzoyl-L-arginine-p-nitroanilide per minute at 22° C. and pH 6.5.

3. Method according to claim 1, wherein the enzyme material is applied to the outside surface of the dough in an amount of at least1×10⁻⁴ Units per cm².

4. Method according to claim 1, wherein following treatment of the outside of the product with the enzyme material, the content of primary amino groups in the top layer is increased by at least 5%.

5. Method according to claim 1, wherein the enzyme material contains one or more botanical or fungal enzymes with proteolytic activity.

6. Method according to claim 1, wherein the enzyme material is applied in the form of a liquid.

7. Method according to claim 1, wherein the enzyme material is applied in the form of an aqueous suspension.

8. Method according to claim 1, wherein the dough is frozen and stored in frozen form for at least 1 day after the enzyme material has been applied.

9. A bread dough product or part baked bread product exhibiting proteolytic activity on the outside surface of the product and exhibiting at least 10 times less proteolytic activity in the interior of the product, said interior of the product being located at least 2 cm away from said outside surface.

10. Product according to claim 9, wherein the proteolytic activity on the outside surface is at least 1×10⁻⁴ Units per cm² and wherein the proteolytic activity inside the product is at least 10 times lower than the same activity on the outside surface, the inside of the product being located at least 2 cm away from said outside surface.

11. Product according to claim 9, wherein the product is frozen.

12. (canceled)

13. Use of an enzyme material exhibiting proteolytic activity for improving the crispiness of baked bread, said use comprising applying the enzyme material to the outside surface of a bread dough or a part baked bread prior to final baking.

14. Method according to claim 1, further comprising the step of partially baking the dough prior to the applying step.

15. Method according to claim 1, wherein the enzyme material is applied after proofing.

16. Product according to claim 10, exhibiting at least 50 times less proteolytic activity in the interior of the product.

17. Method according to claim 2, wherein the enzyme material is applied to the outside surface of the dough or part baked bread in an amount of at least 1×10⁴ Units per cm².

18. A bread dough product or part baked bread product, wherein the concentration of primary amino groups in the top layer of the product is at least 5% higher than inside the product, the inside of the product being located at least 2 cm away from the outside surface.

19. A part baked bread product or fully baked bread product wherein the concentration of primary amino groups in the crust exceeds the concentration of primary group in the crumb by at least 10%.
